(19) United States
(12) Patent Application Publication
(10) Pub. No.: US 2008/0247938 A1
(43) Pub. Date: Oct. 9, 2008

(54) Process of growing carbon nanotubes directly on carbon fiber

(76) Inventors: Ming-Chi Tsai, Hsinchu (TW); Chuen-Horng Tsai, Hsinchu (TW); Tsung-Kuang Yeh, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,937

(22) Filed: Apr. 5, 2007

(51) Int. Cl. C01B 31/02; B01J 23/00; B32B 9/00

(52) U.S. Cl. 423/447.2; 423/447.3; 428/457; 502/182; 977/742; 977/843

(57) ABSTRACT

A process for growing a carbon nanotube directly on a carbon fiber includes at least the steps of depositing a metallic film of at least 1 nm in thickness on at least one surface of a flake-shaped carbon-fiber substrate; placing the substrate into a reactor; introducing a gas including carbon-containing substances into the reactor as a carbon source needed for growing a plurality of carbon nanotubes (CNTs); and thermally cracking the carbon-containing substances in the gas to grow the carbon nanotubes directly on the substrate.

### BACKGROUND OF THE PRESENT INVENTION

1. Field of the Present Invention

The present invention generally relates to a process for growing carbon nanotubes directly on carbon fiber.

2. Description of the Related Art

Nanometer-scale active carbon balls, also called carbon black, are commonly used as electrode catalyst supports of proton exchange membrane fuel cells (PEMFCs) and direct methanol fuel cells (DMFCs). When carbon black is used as an electrode catalyst carrier in a fuel cell, the catalyst is usually deposited onto carbon black via chemical reduction, and then a catalyst mixture is prepared by mixing the catalyst/carbon black with a diluted Nafion® solution. The mixture is applied over a carbon-fiber diffusion layer such as carbon cloth or carbon paper to comprise the electrodes of a fuel cell. However, applying this mixture over the carbon-fiber diffusion layer (ink process) forms multiple laminates overlaying one another, reducing the inherently high specific surface area and thus the total surface area of the catalyst that is usable.

In a direct methanol fuel cell, electrochemical energy is directly converted into electric energy to generate current. At the anode of the methanol fuel cell, fuel (methanol) is disassociated to release protons and electrons. Protons reach the cathode of the battery through a proton exchange membrane, while electrons reach the cathode through an external loop. Protons and electrons react with oxygen molecules at the cathode to form water. The reaction formula is shown as follows.

Anode:CH₃OH+H₂O→CO₂+6H⁺+6e⁻

Cathode:3/2O₂+6H⁺+6e⁻→3H₂O

Total reaction:CH₃OH+H₂O+3/2O₂→CO₂+3H₂O

From the above formula, six electrons are involved in the reaction of the direct methanol fuel cell. Resistance at the interface between the catalyst layer and the diffusion layer inside the fuel cell must be as low as possible so that a significant voltage loss can be avoided.

The ink process not only reduces the total surface area of the catalyst but also increases the resistance at the interface between the catalyst layer and the diffusion layer. Therefore, there is a need for nanometer-scale carbon material as a catalyst for a fuel cell that meets the requirements of a high specific surface area, and low resistance at the interface between the catalyst layer and the diffusion layer.

In the recent years, the use of carbon nanotubes (CNTs) as electrode catalyst support for proton exchange membrane fuel cell and direct methanol fuel cell has drawn a great deal of attention. Nanotubes have, in addition to carbon inherent properties, quasi-one dimensional structures which have a high specific surface area. Such properties allow the nanotubes to serve as the electrode catalyst supports for the fuel cells, increase the distribution of the catalyst over the electrodes and thereby increase the percentage of the catalyst that is used. Attempts have been made to use carbon black as electrode catalyst carriers of fuel cell. In these cases, a catalyst is deposited onto the carbon black via chemical reduction, and then a mixture obtained by mixing the catalyst/carbon black with diluted Nafion® solution. The mixture is applied over a carbon-fiber diffusion layer such as carbon cloth or carbon paper in fuel cells. However, applying this mixture over the carbon-fiber diffusion layer (ink process) forms multiple laminates overlaying one another, reducing the inherently high specific surface area and thus the total surface area of the catalyst.

The inventors have intensively studied the above shortages of the conventional electrode catalyst supporter material for fuel cells, and have finally invented a novel nanotube and a process for growing a nanotube directly on a carbon fiber.

### SUMMARY OF THE PRESENT INVENTION

It is an object of the present invention to provide a process for growing a nanotube directly on a carbon fiber using a flake-shaped carbon-fiber substrate on which at least one metallic film and one catalytic metallic layer are successively deposited and a carbon nanotube with a high specific surface area and low electrochemical resistance is thereby grown.

In order to achieve the above and other objectives, the present invention provides a carbon nanotube directly grown on a carbon fiber. The carbon nanotube includes a carbon-fiber substrate, a metallic film on the substrate and a catalytic metallic layer on the metallic film.

The invention further provides a process for growing a nanotube directly on a carbon fiber. The process includes providing a carbon-fiber substrate; depositing a metallic film onto at least one surface of the carbon-fiber substrate; depositing a catalytic metallic layer onto the metallic film; putting the substrate into a reactor; introducing a gas including carbon-containing substances into the reactor as a carbon source needed for growing the nanotubes; and thermally cracking the carbon-containing substances in the gas to grow a plurality of nanotubes directly on the substrate.

To provide a further understanding of the present invention, the following detailed description illustrates embodiments and examples of the present invention, this detailed description being provided only for illustration of the present invention.

### BRIEF DESCRIPTION OF THE DRAWINGS

FIG. 1 is a schematic view of a carbon nanotube directly grown on a carbon fiber according to one embodiment of the invention.

FIG. 2 is a flow chart of a process for growing a carbon nanotube directly on a carbon fiber according to one embodiment of the invention.

FIG. 3A is a photo taken by a scanning electron microscope showing Ni nanometer-scale particles on a fiber surface of a carbon cloth after thermal pre-treatment according one embodiment of the invention.

FIG. 3B is a photo taken by a scanning electron microscope showing carbon nanotubes grown according to one embodiment of the invention.

FIG. 4A and FIG. 4B, which are photos taken by a scanning electron microscope showing grown carbon nanotubes using nickel/carbon cloth testaments according to one embodiment of the invention.

FIG. 5A is a graph of a Cyclic Voltammetry (CV) of carbon nanotubes/carbon cloth and carbon black/carbon cloth according to one embodiment of the invention.

FIG. 5B is a graph of an electrochemical alternating resistance process of carbon nanotubes/carbon cloth and carbon black/carbon cloth according to one embodiment of the invention.

### DETAILED DESCRIPTION OF THE EMBODIMENTS

Wherever possible in the following description, like reference numerals will refer to like elements and parts unless otherwise illustrated.

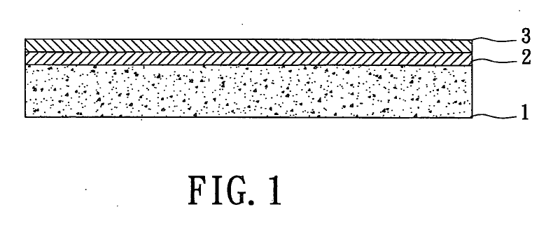

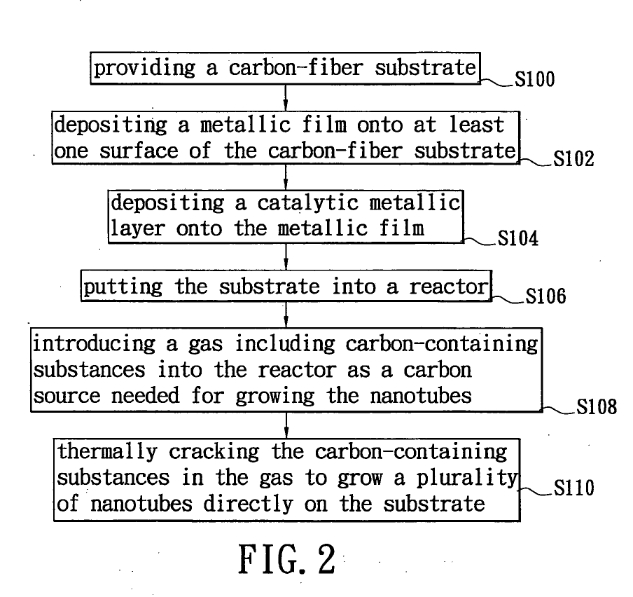

Referring to FIG. 1 and FIG. 2, the process of growing carbon nanotubes directly on carbon fibers according to one embodiment of the invention includes steps of providing a carbon-fiber substrate 1 (S100); depositing a metallic film 2 onto at least one surface of the carbon-fiber substrate 1 (S102); depositing a catalytic metallic layer 3 onto the metallic film 2 (S104); putting the substrate 1 into a reactor (S106); introducing a gas including carbon-containing substances into the reactor as a carbon source needed for growing the nanotubes (S108); and thermally cracking the carbon-containing substances in the gas to grow a plurality of nanotubes directly on the substrate 1 (S110).

The carbon-fiber substrate 1 is a substrate that is flake-shaped. The carbon-fiber substrate 1 can be made into fabric or paper form, for example a carbon textile or carbon paper sheet. The metallic film 2 has a thickness of at least 1 nanometer, and contains, in atomic ratio, at least 1% titanium, at least 1% palladium, at least 1% gold, at least 1% chromium, at least 1% molybdenum, or at least 1% aluminum. The catalytic metallic layer 3 has a thickness of at least 1 nanometer. The catalytic metallic layer 3 can be a catalyst for growing the nanotubes. The catalytic metallic layer 3 contains, in atomic ratio, at least 1% iron, 1% cobalt, or 1% nickel.

In addition to the carbon-containing substances, the gas further contains at least one ammonia gas. The temperature for thermal cracking is 500-1000° C. The time period for thermal cracking is at least 5 min. The nanotube has a diameter of at least 1 nanometer and a length of at least 500 nanomters.

In the present invention, the nanotubes are grown directly on the substrate 1 such as carbon cloth or carbon paper sheet via thermal chemical vapor deposition (thermal CVD).

The substrate 1 is prepared as follows: a 30 nm-thick Ti film 2 is formed over a carbon cloth by E-Gun Evaporation. Subsequently, a 10 nm-thick catalytic metallic layer 3 of Ni needed for growing the carbon nanotubes is deposited onto the Ti film 2 by using the same method as the one used to form the Ti film 2. By means of thermal chemical vapor deposition, the Ni layer 3 is subjected to a thermal pre-treatment to form nanometer particles that are 20-40 nm in diameter. Next, a gas mixture containing carbon source (ethylene) is introduced to grow the nanotubes directly onto the substrate 1 with high specific surface area. In the thermal pre-treatment, the gas mixture of 200 sccm argon and 200 sccm ammonia gases is kept at the temperature of 800° C. for 10 min. In growing the nanotubes, the gas mixture of 280 sccm argon, 90 sccm ammonia and 30 sccm ethylene is kept at the temperature of 800° C. for 10 min.

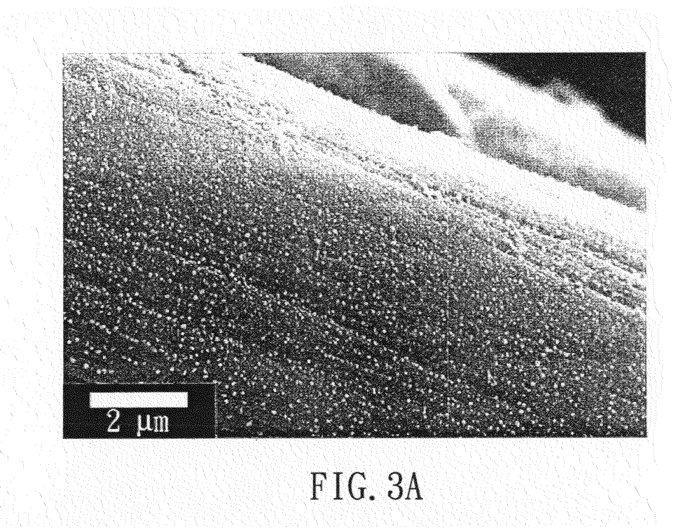

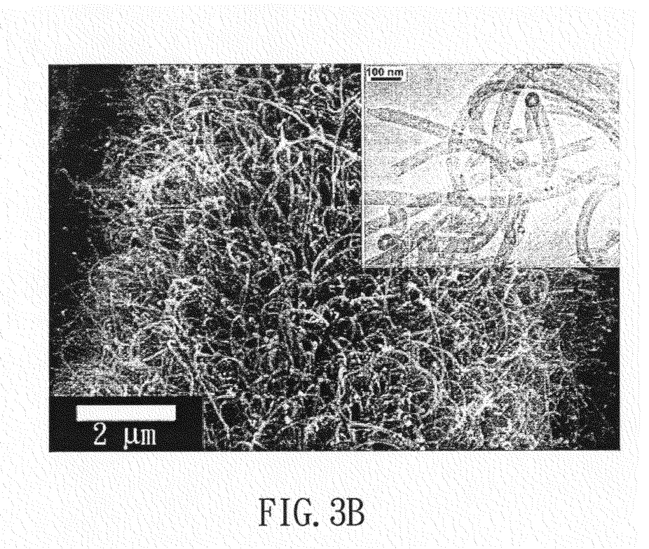

Referring to FIG. 3A, which is a photo taken by a scanning electron microscope showing Ni nanometer-scale particles on a fiber surface of a carbon cloth after thermal pre-treatment according one embodiment of the invention. The conditions for the thermal pre-treatment in this embodiment are a temperature of 800° C. and a gas mixture of 200 sccm argon and 200 sccm ammonia gases. After the thermal pre-treatment is performed for 10 min, it is found that Ni nanometer-scale particles of diameter ranged from 20 nm to 40 nm are uniformly distributed over the surface of the carbon fiber. Referring to FIG. 3B, which is a photo taken by a scanning electron microscope showing carbon nanotubes grown according to one embodiment of the invention. The conditions for growing carbon nanotubes are (1) the gas mixture of 200 sccm argon and 200 sccm ammonia gases must be kept at the temperature of 800° C. for 10 min at thermal pre-treatment stage; and (2) the gas mixture of 280 sccm argon, 90 sccm ammonia gases and 30 sccm ethylene must be kept at the temperature of 800° C. for 10 min during the carbon nanotube growing stage. Thereby, dense carbon nanotubes are formed on the carbon cloth.

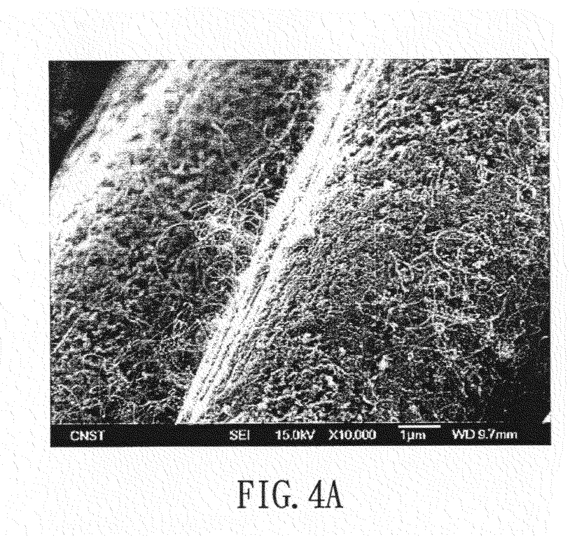

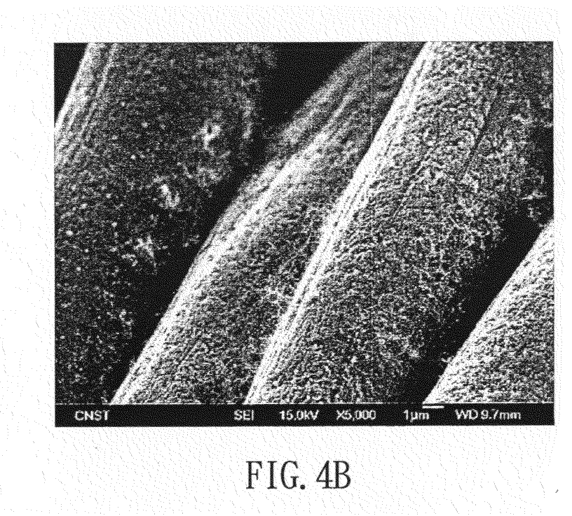

Referring to FIG. 4A and FIG. 4B, which are photos taken by a scanning electron microscope showing grown carbon nanotubes using nickel/carbon cloth testaments according to one embodiment of the invention, conditions for growing the carbon nanotubes are (1) the gas mixture of 200 sccm argon and 200 sccm ammonia gases must be kept at the temperature of 800° C. for 10 min at thermal pre-treatment stage; and (2) the gas mixture of 280 sccm argon, 90 sccm ammonia gases and 30 sccm ethylene must be kept at the temperature of 800° C. for 10 min during the carbon nanotube growing stage.

Comparing FIG. 3 with FIG. 4, which shows the carbon nanotubes formed by the same process as the one used to form the carbon nanotubes shown in FIG. 3 except the Ti film 2 has been added, it is found that the presence of Ti film 2 effectively improves adhesion between the carbon nanotubes and the carbon fibers.

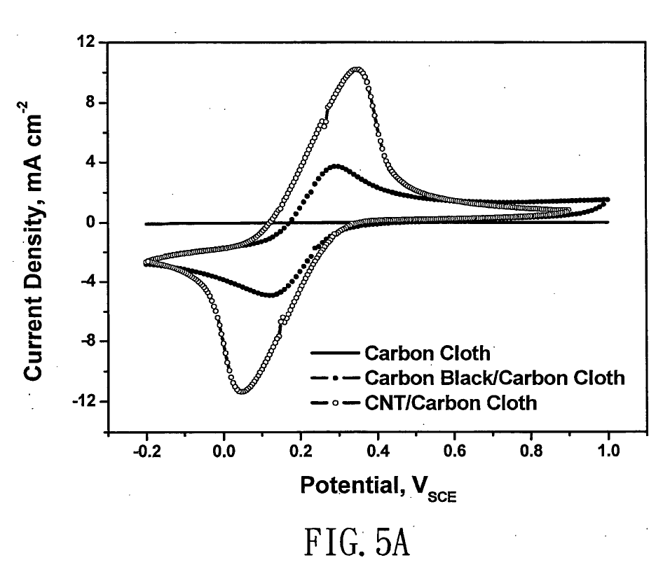

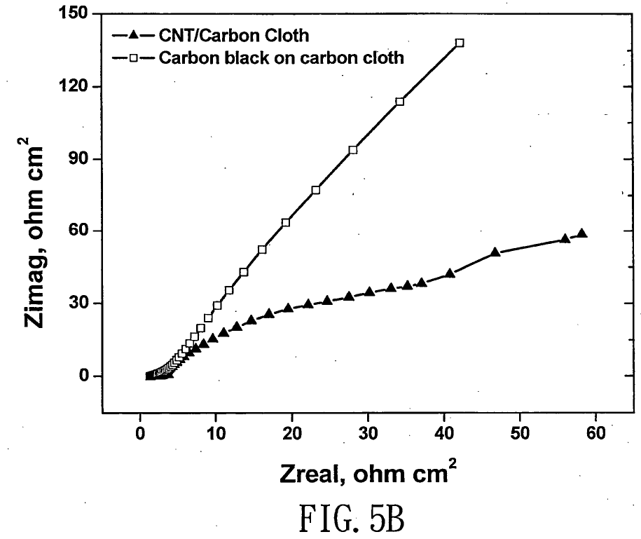

FIG. 5A is a graph of a Cyclic Voltammetry (CV) of carbon nanotubes/carbon cloth and carbon black/carbon cloth according to one embodiment of the invention, wherein the Cyclic Voltammetry is performed at scanning potential of −0.2˜1.0 V_{SCE} and scanning speed of 50 mV/sec by using an aqueous solution of 0.1 M de-oxygen potassium sulfate and 5 mM potassium ferricyanide. FIG. 5B is a graph of an electrochemical alternating resistance of carbon nanotubes/carbon cloth and carbon black/carbon cloth according to one embodiment of the invention, wherein the electrochemical alternating resistance process is performed at a scanning frequency of 0.003-10000 Hz and an alternating voltage of 10 mV by using an aqueous solution of 0.1 M de-oxygen sulfuric acid and 5 mM potassium ferricyanide. From results obtained by means of measuring an electrochemical reaction area and electrochemical resistance by using Cyclic Voltammetry (CV) and an electrochemical resistance process, it is found that electrochemical reaction area and electrochemical resistance on electrodes made of carbon nanotrubes/carbon cloth obtained by the invention has superior performance to those of carbon cloth and carbon black/carbon cloth in the art.

In view of the foregoing, the invention provides advantages over the prior art as follows: the carbon nanotubes of the present invention have a high specific surface area. The presence of the Ti film 2 significantly improves adhesion between the nanotubes and the carbon fiber substrate 1. The electrochemical reaction area and the electrochemical resistance of the electrodes made of carbon nanotubes/carbon cloth are superior to those of carbon cloth and carbon black/carbon cloth in the art.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A carbon nanotube directly grown on a carbon fiber, comprising:
a carbon-fiber substrate;
a metallic film, deposited on at least one surface of the substrate; and
a catalytic metallic layer, deposited on the metallic film.

2. The carbon nanotube of claim 1, wherein the carbon-fiber substrate is a substrate that is flake-shaped.

3. The carbon nanotube of claim 1, wherein the carbon-fiber substrate is a carbon cloth.

4. The carbon nanotube of claim 1, wherein the carbon-fiber substrate is a paper sheet.

5. The carbon nanotube of claim 1, wherein the metallic film has a thickness of at least 1 nanometer.

6. The carbon nanotube of claim 1, wherein the metallic film contains, in atomic ratio, at least 1% titanium, at least 1% palladium, at least 1% gold, at least 1% chromium, at least 1% molybdenum, or at least 1% aluminum.

7. The carbon nanotube of claim 1, wherein the catalytic metallic layer has a thickness of at least 1 nanometer.

8. The carbon nanotube of claim 1, wherein the catalytic metallic layer is a catalyst for growing the nanotubes.

9. The carbon nanotube of claim 1, wherein the catalytic metallic layer contains, in atomic ratio, at least 1% iron, 1% cobalt, or 1% nickel.

10. The carbon nanotube of claim 1, wherein the metallic film is an electrical-conducting film.

11. A process for growing carbon nanotubes directly on a carbon fiber, comprising
providing a carbon-fiber substrate;
depositing a metallic film onto at least one surface of the carbon-fiber substrate;
depositing a catalytic metallic layer onto the metallic film;
putting the substrate into a reactor;
introducing a gas including carbon-containing substances into the reactor as a carbon source needed for growing a plurality of carbon nanotubes; and
thermally cracking the carbon-containing substances in the gas to grow the carbon nanotubes directly on the substrate.

12. The process of claim 11, wherein the carbon-fiber substrate is a substrate that is flake-shaped.

13. The process of claim 11, wherein the carbon-fiber substrate is a carbon cloth.

14. The process of claim 11, wherein the carbon-fiber substrate is a paper sheet.

15. The process of claim 11, wherein the metallic film has a thickness of at least 1 nanometer.

16. The process of claim 11, wherein the metallic film contains, in atomic ratio, at least 1% titanium, at least 1% palladium, at least 1% gold, at least 1% chromium, at least 1% molybdenum, and at least 1% aluminum.

17. The process of claim 11, wherein the catalytic metallic layer has a thickness of at least 1 nanometer.

18. The process of claim 11, wherein the catalytic metallic layer is a catalyst for growing the nanotubes.

19. The process of claim 11, wherein the catalytic metallic layer contains, in atomic ratio, at least 1% iron, 1% cobalt, and 1% nickel.

20. The process of claim 11, wherein the gas at least contains ammonia gas.

21. The process of claim 11, wherein the temperature of thermally cracking is 500° C.-1000° C.

22. The process of claim 11, wherein the thermally cracking is performed for at least 5 minutes.

23. The process of claim 11, wherein the nanotube has a diameter of at least 1 nanometer and a length of at least 500 nanomters.
